(19) United States
(12) Patent Application Publication
(10) Pub. No.: US 2025/0379754 A1
(43) Pub. Date: Dec. 11, 2025

(54) PHYSICALLY UNCLONABLE FUNCTIONS (PUFS) WITH DIFFERENT PATHS OF SENSOR DEVICES THAT ARE RANDOMLY ADDRESSABLE

(71) Applicants: The Arizona Board of Regents for and on behalf of Northern Arizona University, Flagstaff, AZ (US); Brown University, Providence, RI (US)

(72) Inventors: Julie HEYNSSENS, Flagstaff, AZ (US); Bertrand F. CAMBOU, Flagstaff, AZ (US); Taylor BEGAY, Flagstaff, AZ (US); Jack GARRARD, Flagstaff, AZ (US); Mahafujul ALAM, Flagstaff, AZ (US); Ian BURKE, Flagstaff, AZ (US); Ruben MONTANO CLAURE, Flagstaff, AZ (US); Lucas CARETTA, Providence, RI (US)

(21) Appl. No.: 19/231,860

(22) Filed: Jun. 9, 2025

Related U.S. Application Data
(60) Provisional application No. 63/657,614, filed on Jun. 7, 2024.

(51) Int. Cl. H04L 9/32; H04L 9/08

(52) U.S. Cl. CPC H04L 9/3278; H04L 9/0866

(57) ABSTRACT

An arrangement and methods of using a sensor as a PUF is described. The sensor includes individually addressable sub elements. The sensor's output signal is a function of the response of its individually addressable sub elements, but the individual responses of sub elements are used as a CRP generation mechanism. Responses from the pairs of individually addressable sensor elements over ranges of environmental inputs are a unique sensor fingerprint and may be used for authentication, encrypted communication and for hardware tracking, as well as for detection of bad portions of the sensor or error injection attacks.

### CROSS-REFERENCE TO RELATED APPLICATIONS

The present application claims priority to U.S. Provisional Application 63/657,614 of the same title, filed on Jun. 7, 2024, the contents of which is incorporated herein by reference in its entirety.

### STATEMENT REGARDING FEDERALLY SPONSORED RESEARCH

This invention was supported by the United States Government under grant number 1005387 awarded by U.S. Department of Defense. The Government has certain rights in the invention.

### BACKGROUND OF THE INVENTION

Information is frequently encrypted to protect against eavesdropping and unauthorized access using encryption schemes based on the use of one or more encryption keys and other keyless encryption schemes. Encryption schemes are frequently used in conjunction with authentication schemes to improve the security of electronic systems. Increasingly, Physical Unclonable Functions (PUFs) are used as the basis for encryption and authentication schemes, and in particular, for encryption key generation. PUF-based security systems use a PUF device as an “electronic fingerprint” unique to a user or device in possession or control of the PUF device, allowing an authentication system to challenge a client seeking authentication, receive a response generated by the client using a PUF device, and then compare the received with a stored response previously received from the client or derived from characteristics of the PUF device and verifying that the two responses match.

More generally, PUFs are security primitives that can be used wherever secret or unique random values are needed. A PUF can be described as a digital function f which takes an n-bit challenge C and produces an m-bit response R. The function f is a random function that can only be evaluated with the help of a specific physical system and outputs repeatable responses that are different for each physical system and for each challenge. They exploit the intrinsic randomness of a measurable physical characteristics of the PUF system to do this. Thus, a PUF is a physical entity that is relatively easy to make and evaluate, but that is unique (i.e., impractical to duplicate), and should generate an unpredictable but repeatable response to a given physical stimulus (i.e., a measurement of some characteristic, which will be referred to below as a “challenge”). A good PUF should also demonstrate low collisions, that is, ideally, no two different challenges should generate the same response.

Many objects and devices have been suggested for use as PUFs, for example, certain electronic devices, physical objects such as biological objects or natural objects, or images of objects. One frequently used class of PUF is the hardware or integrated circuit PUF. An integrated circuit (IC) PUF exploits random manufacturing process variations in a specific structure (e.g., an array) of circuits to produce a fixed response for a given challenge. Exemplary hardware/IC PUF devices include SRAM cells; ring oscillator circuits (e.g., as shown in FIG. 1); gate delay circuits; resistive memory devices; ferroelectric memory devices; phase change memory devices; magnetic memory devices; flash memory devices; and one-time programmable memory devices. Non-limiting examples of measurable physical characteristics of devices used in PUF arrays are time delays of transistor-based ring oscillators and transistor threshold voltages. Additional examples include data stored in SRAM or information derived from such data. For example, an SRAM PUF exploits the metastability in the start-up process of SRAM cells.

As noted, PUFs generate outputs referred to herein as responses from inputs known as challenges. Each PUF is defined by its set of Challenge/Response Pairs (CRPs), and these CRPs are ideally unique for each PUF device. In the case of hardware PUFs that are based on electronics (e.g., because manufacturing processes are inherently variable. PUFs primarily serve two essential functions: secure key generation and cost-effective authentication. These distinct applications originate from the categorization of PUFs into two groups: strong and weak. Weak PUFs are primarily used for generating and securely storing cryptographic keys, whereas strong PUFs excel in the realm of device authentication. The primary distinguishing feature between these two categories lies in their capacity to handle different quantities of distinct challenges. Weak PUFs can handle only a limited number of challenges, sometimes just one, while strong PUFs can accommodate a significant number of challenges, rendering it virtually impossible to measure all possible challenge/response pairs (CRPs) within a practical timeframe.

Sensors are electronic devices that convert physical and/or chemical signals into electric signals driving microelectronic systems. Sensors are increasingly prevalent as they are critical for device automation (e.g., robots, self-driving cars and drones) and are integral components of the extensive network of interconnected Internet of Things (IoT) devices. Sensors generally play an important role in perceiving the surrounding environment, collecting valuable data, and sharing this data with other connected devices. However, sensors are especially susceptible to security threats due to their widespread deployment and exposure to potentially hostile environments. It is worth highlighting that IoT devices often find application in contexts where security and privacy are of paramount concern, such as in e-health, smart homes, and the monitoring of critical infrastructure. Sensors that are associated with vehicles, industrial systems and robots must be kept reliable and secure. Malicious breach of networks including these sorts of sensors may have disastrous consequences for human safety.

It has been suggested that sensors themselves may be used as PUFs. For example, U.S. Pat. No. 11,533,188, entitled “Multi-PUF Authentication From Sensors and Their Calibration” suggests the use sensors and sensor calibration data as PUFs. The disclosure of that patent is incorporated herein by reference in its entirety. The aforementioned patent notes that sensors are generally calibrated prior to use resulting in a calibration table. During a calibration process, a sensor is exposed to a range of known environmental stimuli corresponding to a range of environmental stimulus that the sensor will be expected to measure in use. For example, a temperature sensor may have an operational range of between 0 and 100 degrees C., and so to calibrate the sensor, it will be exposed to temperatures over that range, and its electronic output will be tracked. Because of random and unpredictable device and manufacturing variations, the measured electronic output will not track the expected electronic output. To make the sensor accurate, a calibration table will be built that provides a table of scale factors for each degree in temperature that the raw electronic output of the sensor should be multiplied by to result in the correct and aperture temperature reading. The aforementioned patent notes that this calibration table embodies random and unique variations of the sensor from an ideal sensor, and therefore the calibration table itself can be used as a PUF and a CRP generator. Here, the challenges would be environmental stimulus values (e.g., temperature values), and the responses would be the calibration scale factors at those environmental stimulus values.

In another embodiment described in U.S. Pat. No. 11,533,188, two sensors are provided, one of which is calibrated and the other of which is not calibrated. In these embodiments, a measured difference between the calibrated electronic output signal of the calibrated sensor and the uncalibrated raw electronic output signal of the uncalibrated signal reflects the random device and manufacturing variations in the uncalibrated sensor in the same way a calibration table would. Similar disclosure is provided in U.S. Pat. No. 11,303,460 entitled “PUFs from sensors and their calibration”, which is also incorporated by reference herein in its entirety.

While the methods described in the aforementioned U.S. patents for using sensors as PUFs are advantageous, they are amenable to improvement. For example, calibration table PUFs may have undesirably levels of entropy because of the limited size of table. Further improvement is warranted.

### BRIEF SUMMARY

Embodiments of the invention are directed to arrangements and methods for using sensor arrays, having individually addressable sensor elements, as PUFs. In a manner similar to how ring oscillator PUFs are challenged, inventive embodiments are directed to an arrangement allowing randomly addressable paths that are applied to pairs of individually addressable sensor elements or individually addressable groups of sensors elements (e.g., arrays of rows of sensors). Rather than counting oscillations as in the case of ring-oscillators, which is a slow process and carries the risk of exposure to E-M side-channel analysis, in one embodiment, two randomly addressed paths of groups of sensor devices (or individually addressable sensor elements in a sensor) are compared in real-time. The comparison can be done on the basis of any number and/or a combination of different physical properties, including but not limited to, by measuring voltages, currents, capacitance, impedance, resistance values, or electric charges. In certain cases, when the value of the first sensor element (e.g., a first row) of each pair is lower than the second element, the resulting response is read as a “0”; when higher, it is a state of “1”.

The challenge or input parameter of such a PUF may be seed that may be read as a stream of addresses needed to find a sequence of pairs of rows. The output parameter of the PUF, the response, is the stream of bits resulting from the comparisons. The responses become the fingerprints of the PUF for random seed and cryptographic key generation. Such fingerprinting done in real-time can also be used to enhance the resilience of the electronic system using the device as sensor.

Using pairs of individually measurable sensor elements or sub elements as PUFs has certain advantages, even over the prior sensor-based PUF disclosures cited and incorporated in this application. First, where a sensor is decomposable into individually accessible and measurable elements, the entropy of the PUF is greatly increased. For certain sensors, randomly generating challenges that comprise pairs of addressable sensor elements can easily result in an almost infinite set of 256 sensor element pairs. A typical cellular phone camera's detector array, for example, has 2 k×3 k or 6M pixels, which would yield n(n−1)/2 individual pairs of pixels or about 18M pairs.

Additionally, as noted above, measuring simple electrical properties of the sensor elements can be done quickly, in contrast to the time required to count pulses while measuring ring oscillator PUFs.

Additionally, for certain sensor types, the entropy may be increased by adding an additional layer of electronic stimulus input to the environmental stimulus. In this way sensor PUFs differentiate themselves from traditional PUFs by accepting two different types of inputs: an input challenge and a physical quantity, which can be expressed as voltage, current, etc.

Additionally, by repeatedly comparing the responsivities of pairs of individual sensor elements, arrangements according to the inventive embodiment can detect malfunctioning sensor elements or malicious error injunctions. This added capability expands the horizons of PUF applications, enabling the detection of malfunctioning sensors. Consequently, sensor PUFs significantly contribute to enhancing the overall robustness and reliability of systems.

Additional advantages will become clear upon consideration of the following description of preferred embodiments.

### BRIEF DESCRIPTION OF THE DRAWINGS

The drawings described herein constitute part of this specification and include exemplary embodiments of the present invention which may be embodied in various forms. It is to be understood that in some instances, various aspects of the invention may be shown exaggerated or enlarged to facilitate an understanding of the invention. Therefore, drawings may not be to scale.

FIG. 1 depicts a ring oscillator based PUF hardware for the generation of shared random numbers between a client device containing the PUF and a server containing an image of the PUF.

FIG. 2 depicts example circuitry for a Sensor row based PUF that utilizes an array of sensing elements. This system is capable of generating random seeds and encryption keys, sensing the state of external stimuli, and detecting in real-time if any of the elements in the sensing array has been damaged.

FIG. 3 depicts an array of ferroelectric elements as an example of an array to be used for Sensor based PUF that is capable of real-time detection of the failure of individual array elements and also generating cryptographic primitives.

FIG. 4 depicts single-probe measurements of pristine HZO measured at 400 nA current injections.

### DETAILED DESCRIPTION

The described features, advantages, and characteristics may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment. References to “users” refer generally to individuals accessing a particular computing device or resource, to an external computing device accessing a particular computing device or resource, or to various processes executing in any combination of hardware, software, or firmware that access a particular computing device or resource. Similarly, references to a “server” refer generally to a computing device acting as a server, or processes executing in any combination of hardware, software, or firmware that access control access to a particular computing device or resource.

It is contemplated that, in preferred embodiments, the methods described below will be carried out in a computing environment including at least a first computing device, and in some cases a second computing device in electronic, network communication with one another. The first device will be referred to as a “server” or a “central” device, and the second device will be referred to as a “client” or a “terminal” device. References to “users” refer generally to individuals accessing a particular computing device or resource, to an external computing device accessing a particular computing device or resource, or to various processes executing in any combination of hardware, software, or firmware that access a particular computing device or resource. Both the client and server devices are, preferably, at least general-purpose computing devices, which may include non-volatile storage, a programmable processor, input/output devices, and network interface devices. The non-volatile storage may encode computer readable instructions that, when executed, cause the processors in the server and client devices to execute the method steps described throughout this disclosure.

At least one of the aforementioned computing devices may be in possession of PUF, which may be an addressable sensor array as described below. As stated above, a PUF is usable as a CRP generation mechanism and may be used for cryptographic key generation and authentication of parties. The use of PUFs for cryptographic purposes is described generally in U.S. Pat. No. 11,283,633, entitled “PUF-based key generation for cryptographic schemes”, and U.S. Pat. No. 11,552,787, entitled “Key exchange schemes with addressable elements”. As is set forth in those references, both of which are incorporated by reference herein in their entireties, a PUF may be used as a one-way function, not unlike a cryptographic hash function, for tasks like key generation. The PUF is preferably an addressable array of PUF devices (e.g., an SRAM, where each individual RAM cell is a device). The device in possession of the physical PUF also has whatever electronics are necessary to address and provide challenges to the PUF (e.g., multiplexers and demultiplexers, drivers, signal generators, DACs and ADCs, etc.). The combination of the electronics necessary to challenge an addressable PUF array and the addressable PUF array itself is referred to as an addressable PUF generator or APG. The inclusion of an APG in a device will take it outside the realm of general purpose devices and renders the device specialized.

In the embodiments that follow, at least one computing device will generally be in possession of a APG including an addressable PUF array. The purpose of the APG is to issue challenges to the PUF, from which responses can be read. A PUF response, particularly for the sort of hardware PUFs described below, is measurement data reflecting some physical characteristic of one or more PUF devices (e.g., current, voltage, resistance, etc.) that can be measured. A challenge will generally specify one or more addresses of individual PUF devices to be measured, e.g., a set of address values ‘x’ and ‘y’. The challenge may additionally specify measurement conditions under which the response is to be generated (e.g., ambient temperature, electronic signals applied to devices, etc.). The challenge is generated by a device's programmable processor and passed to the APG which locates the corresponding address in the PUF and directs electronics to apply specified measurement conditions, if being used. The PUF's response to the received challenge (e.g., measurement data reflecting some physical property or state of the PUF device) is generated and read by the device.

Devices equipped with PUFs and APG can be used for a variety of cryptographic and non-cryptographic functions, such as cryptographic key generation. In an exemplary process, a PUF is “enrolled” or characterized at a first computing device which may be server computing device. In the enrollment process, a set of challenges is generated and applied through an APG to the PUF, and a set of corresponding responses is read. The challenges and the corresponding responses are stored in a database. The challenges should be a comprehensive set, that is, every challenge that might be used in the future for communication purposes. A typical way to generate challenges is to generate a random bitstream with a random number generation process running on the first computing device's processor, and then parse the bits of the stream into PUF device addresses and measurement conditions. Other input may be part of the challenge generation process such as user supplied passwords. The objective of the enrollment process is to be build an “image” of the PUF, that is, a data table that comprehensively reflects how the PUF will respond to any challenge.

As part of the generation and storage of the image, challenges that produce undesirable responses can be identified and excluded from inclusion in future keys. A bad response might be an inconsistent response, that is, if a given a challenge produces multiple responses, that challenge can be exclude from future key generation. Additionally, challenges that result in collisions or near-collisions may be excluded, that is, different challenges that result in the same response or very close responses. In preferred embodiments, a mask is built during enrollment that can be used on future seeds to exclude portions of the seed that correspond to bad challenges. This mask can be passed to the client device so that it does not include these bad challenges in its key generation process.

The enrollment procedure is typically performed by a central server computing device, which is situated in a secure environment. The PUF image is highly sensitive information, so it is typically stored at the server device, again in a secure environment. The PUF itself, and the APG electronics may be physical possession of a second computing device (the client). The server conducts the enrollment process (the comprehensive measurement of the client's PUF) in a secure environment before the client, in possession of the PUF itself, is released into the untrusted environment.

Later, the client's PUF, and the server's image of the PUF, may be used to generate cryptographic keys that may be used to authenticate one other, or to encrypt and decrypt communications between the devices. This process may begin with a handshake contact between the two devices (in either direction) signaling a desire to communicate. Each device then independently generates a set of the same PUF challenges. This may be accomplished by each device using a piece of shared information to generate the challenges, or one device may generate a seed (e.g., with an RNG) and send it to the other device, and the now-shared seed may used. Each device may have its own parallel copy of a set of pre-generated seeds. In any event, using some piece of shared information, each device independently generates a set of processing instructions (challenges for the PUF). There may be optional hashing steps involved in converting the seeds to challenges for additional security.

With parallel sets of identical challenges in hand, the client applies the challenges to its PUF, and the server applies to the challenges to its copy of the PUF (i.e., the image). Each party then retrieves the same set of responses, which may be used to generate a key. The resulting key pair may be used for authentication (e.g., by producing cryptographic signatures that can be compared), and can encrypt and decrypt files to be exchanged between the parties.

The just described method is exemplary only—the PUF arrangement below is usable to perform any function performed by PUFs, including but not limited to authentication and key generation.

In the embodiments that follow, it is contemplated that at least one computing device will be in possession of a physical PUF and will include an APG sufficient to apply challenges to the PUF and read responses. For example, a client device that is deployed into an unsecured environment may be in possession of a physical PUF, of the sort described below, and a server device may be in possession of the PUF image (i.e., a lookup table built by supplying a large array of challenges to the PUF and recording the responses such that a comprehensive database of PUF responses is constructed).

In other embodiments, a single device (e.g., a client device that includes a sensor) may be in possession of both the PUF (i.e., the sensor) and the PUF's image, such that it can very for itself continued functioning of the individual sensor elements.

The embodiments now described use arrays of sensor devices as PUFs. A sensor device, generally, is a device that translates some physical, electrical or chemical stimulus into a detectable signal, typically an electrical signal. When the signal is an electrical signal, it may be encoded in any measurable electrical phenomenon (e.g., voltage, resistance, current, waveform frequency, etc.). Sensor devices are increasingly integrated into electronic systems such as mobile devices, Internet of things (IoT), cyber physical systems (CPS), smart grid, medical devices, and safety components. The range of physical and chemical parameters that are converted into usable electronic signals is extremely pervasive, and includes acceleration, rotation, deviation to the magnetic north, electronic currents, motion, image, chemical and biochemical elements, blood composition, heart beat rate, temperature, pressure, mechanical stress, humidity, and many others. A particularly useful and increasingly pervasive class of sensors are ferroelectric sensors. Since ferroelectric sensors may be configured to demonstrate optical, piezoelectric and pyroelectric properties, these sensors are widely and increasingly used as optical sensors (mostly in the IR region), thermal sensors and as various types of mechanical sensors (pressure, acceleration, etc.). Ferroelectric sensors are commonly employed on various IoT smart devices. While the example discussions below focus on individual addressable elements of a ferroelectric sensor, this is not limiting. The invention as described herein is applicable to any time of sensor that has individually addressable elements.

Due to manufacturing variations, two given individual sensors of the same type will generally have a different response even if the sensors were fabricated using the same process. These manufacturing variations that occur in sensors make sensors ideal candidates for use in physically unclonable function (PUF) based security and identification systems, as well as in hardware tracking systems, where a device's unique “fingerprint” may be tracked through the supply chain. Exemplary use of sensor-based PUFs is documented in U.S. Patent Publication No. 2023/0358579 entitled “Enhancing system resilience with differential, sensor-based pufs”, filed as application Ser. No. 18/144,104 on May 5, 2023, as well as in U.S. Pat. No. 11,533,188 entitled “Multi-PUF authentication from sensors and their calibration”, filed as application Ser. No. 16/452,435 on Jun. 25, 2019. Both the aforementioned publication and patent are incorporated herein by reference in their entireties.

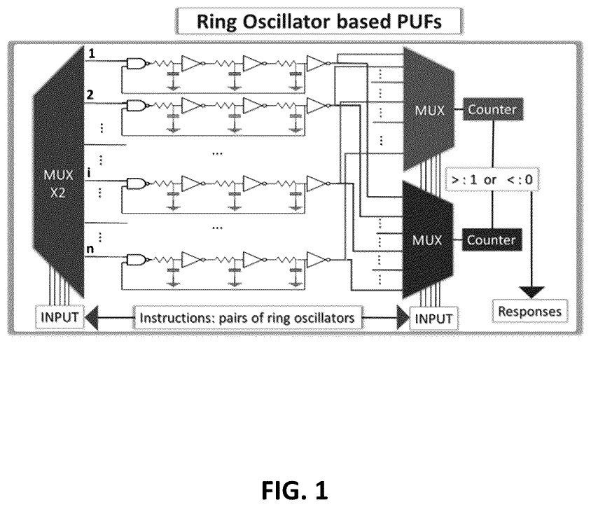

One example of a commonly used PUF is a ring oscillator PUF, such as the one depicted in FIG. 1. Ring oscillator PUFs are generally realized in FPGAs, which in their unprogrammed form, are just arrays of programmable logic gates arranged along addressable rows or in some other programmable matrix. Ring oscillator PUFs, like other hardware PUFs, are capable of generating random but repeatable responses, which can then be used as random seeds for encryption algorithms and generators of shared encryption keys between, for example, a client device containing the PUF and a server that contains an image of the PUF.

As shown in FIG. 1, in a ring oscillator PUF, a multiplexer 100 is connected to a first 105 of an array of n ring oscillators. The multiplexer is also connected each of the other n oscillators, including, for example, second oscillator 130. Instructions (i.e., challenges) are generated that randomly identify two oscillators in the array (e.g., 1, 2). One of the selected oscillator's outputs is connected through a multiplexer 110 to a first frequency counter 115, which measures the frequency of the oscillation being produced by the first oscillator. The other selected oscillator 130 is connected to another multiplexer 120. The second multiplexer 120 output is connected to a second frequency counter 125. The two counter outputs are compared; the faster oscillator of the pair will have the higher count and will determine if the output response is a zero or one. Subsequent pairs of oscillators are selected to generate another single-bit response output. The process continues until the desired number of responses are concatenated into a single random binary string that is measured by the client device containing the PUF and can be computed from an image of the PUF on the server.

Ring oscillators of the sort depicted in FIG. 1 have certain advantages, the chief of which is high entropy. Many individual ring oscillators can be realized in a typical FPGA, which enables many possible combinations of pairs of oscillators from which to elicit a response. One disadvantage of ring oscillator PUFs, however, is that measuring the response by counting is oscillations is a slow process that requires many clock cycles. Another disadvantage is that these devices are subject to side channel attacks-oscillations create electromagnetic signals that are can be broadcast and detected by malicious third parties, who may then be capable of also measuring the responses as they are being generated.

To overcome these disadvantages, this disclosure proposes a new type of non-ring oscillator PUF. A device is provided, which may be a client device as described above, including typical computing device elements. Exemplary devices include a cellular telephone, smart watch, automobile, etc., or some other device having one or more sensors. The sensors have individual addressable elements. For example, the sensor may be an optical sensor with individual pixels that are individually addressable (i.e., individually accessible by device electronics to measure some parameter or physical characteristic of the individual sensor element). In inventive embodiments, a challenge may be generated that comprises data sufficient to identify a pair of addresses each identifying and individual sensor element. The challenge is applied to the pair of sensor elements by measuring a physical characteristic of each device (e.g., some electrical property such as voltage, charge, resistance, capacitance, etc.). The measurements are compared (e.g., with a comparator), and the comparison process outputs a first binary value if a first measurement is above a second measurement and a second binary value if the second measurement is above a first measurement.

Multiple challenges may be generated in the manner disclosed in the references cited herein. For, example, a RNG may be used to generate a random bitstream, the bitstream may be divided into n segments of sufficient bit length such that each segment may be parsed to indicate two sensor addresses. Hashing of random seeds and the incorporation of user supplied passwords may also be incorporated into the challenge generation process.

As in the other PUF embodiments disclosed, it is contemplated that the PUF described herein will undergo an enrollment process, preferably with another computing device such as a server, which will store an image of the PUF for later use in encrypted communication and authentication of the client, which is in possession of the sensor PUF. In preferred embodiments, during enrollment, each individually addressable sensor element is measured to generate a table of its response. That is, each individual sensor element is measured according to whatever physical property is being used as the response (voltage, resistance, capacitance, etc.), and that response date is stored in a look up table in association with the sensor address or identification. Comprehensive characterization of the response of individual sensor sub elements in this manner is complicated by the fact that a sensor element, in use, will be exposed to some physical stimulus that will change its characteristics. That is to say, it is completed that the sensor elements are being used as sensors at the same time they are being used as CRP generators, so the sensors that are deployed into the field on client devices will be experiencing a range of environmental stimulus when they are also being used as CRP generators. This means that when the image of the PUF is being built, response sets must be built for each sensor element under a range of different environmental stimulus for the sensors. If the sensor is a temperature sensor, for example, an image of the sensor-as-PUF will include entries for: the individual sensor element address, a temperature, and a response. In this example, responses would be cataloged over the operational range of temperatures that the sensor will see in use.

It will be noticed that the enrollment/image formation process just described is very similar to the sensor calibration process, and so it is acceptable to build the PUF image at the same time that a sensor calibration table is being built. As stated in this disclosure elsewhere, a sensor calibration table is a table with data sufficient to correct raw electrical sensor output to an electrical output that accurately reflects the physical input being measured by the sensor. One distinguishing characteristic of the instant arrangement over previously disclosed sensor PUFs, however, is that in conventional sensors, a calibration table will typically be prepared for the sensor as a whole, rather than for individual sensor elements. In certain instant embodiments, the responses are generated by measuring individually addressable sub-elements of a sensor, and those individual sub-elements are not typically calibrated, since the calibration data that matters for sensor operation is the calibration of the sensor in the aggregate.

Entropy of this arrangement may be further increased by supplying an electrical stimulus to elicit the response. For example, if the sensor sub-elements are resistive devices, a probe or injection current can be added which will further cause different sensor elements to respond differently (e.g., to have a different measured voltage). Thus, to fully characterize an embodiment of this sort of sensor PUF, it will be necessary to subject the sensor sub-elements to the range of electrical stimulus that will be used during response measurement. This electrical stimulus will be included in the challenges and used during response generation, and this must be done during enrollment as well. In these embodiments, then, an image lookup table may be generated that includes the PUF sensor element address, a physical signal level (e.g., temperature, acceleration, etc.), an electrical stimulus level (e.g., probe current value), and then the measured response. Where this approach is used, the challenge-generating bitstream (i.e., the random seed) may be read such that each challenge also specifies the electrical stimulus level. I.e., each of the n challenge segments might specify: first sensor element address, second sensor element address, electrical stimulus value. The environmental stimulus value that the sensor is experience during the challenge process cannot typically be controlled by the client device, however, this value would be noted along with the responses and used to find the correct enrollment responses against which to compare the contemporaneously measured responses.

As noted above, in preferred embodiments, each sensor sub-element's response is measured during enrollment, optionally as a function of a variety of environmental inputs to the sensor and as a function of a variety of electrical inputs. The challenge responses are preferably a comparison of responses or measurements of pairs of sensor elements. Therefore, in preferred embodiments, the contemporaneously measured responses are compared to responses in the PUF image by identifying (e.g., to the server) sensor element pairs. The server may then query the image for entries to the corresponding sensor elements, then compare the values in the stored image data.

During construction and storage of the image, bad challenges may be identified. A bad challenge may be a challenge that identifies a pair of sensor elements that return the same or vary close measurements. Because of measurement noise, such a pair of elements will sometimes have one element returning a higher result than the other, and sometimes the opposite will be the case, such that the binary output is uncertain and subject to change. In certain embodiments, such element pairs are identified during the image formation process and a mask is constructed that excludes such elements from use in the future.

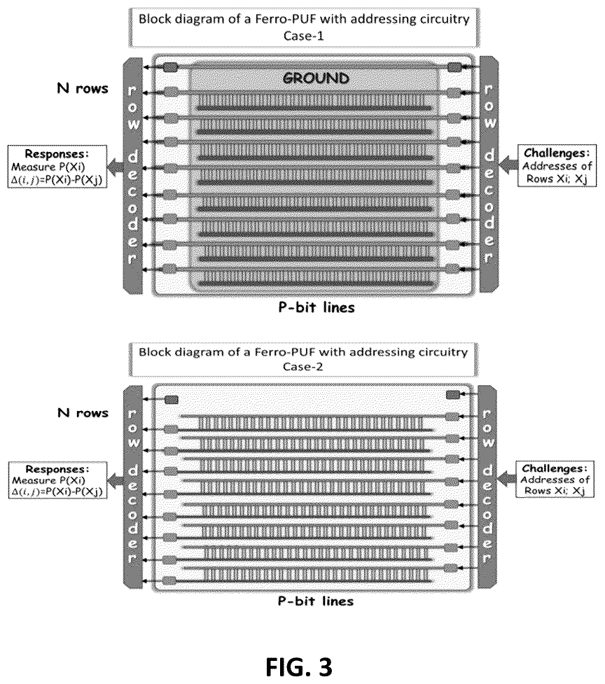

Referring now to FIG. 3, there is an example of a sensor usable as a PUF according to the method described in this disclosure. FIG. 3 shows a sensor 300. Sensor 300 is configured to output an electrical signal in response to a physical input signal, however, sensor 300 comprises a plurality of individually addressable (i.e., individually measurable) sub elements 305, which are the sensor elements referred to above. In use, the electrical signal generated by sensor 300 is generated by the aggregate of individually addressable sub elements 305, however, individually addressable sub elements 305 have slightly different properties from one another due to manufacturing variations, these slightly different properties can be measured, in a pair wise manner, to generate responses. In the example of FIG. 3, the individual sensor elements 305 are rows of individual ferroelectric devices that are arranged in electrical parallel between rails as shown. Ferroelectric materials are capable of sensing a wide array of environmental conditions including infrared radiation, temperature, and stress. Ferroelectric materials also have a memory effect and store charge in an induced electric field and maintain that charge after the charging electric field is removed. In addition to that, ferroelectric materials can be used in high-permittivity dielectrics, pyroelectric sensors, and piezoelectric devices. In certain conditions ferroelectric materials can have lower impedance e.g, high dielectric constants, which enables the Ferroelectric material to act as an effective capacitor. Linear rows of ferroelectric sensors will have lower output impedance allowing the output of the array (i.e., the aggregate sensor reading) to be read out more accurately be external electronics.

In the arrangement of FIG. 3, first and second row encoders 310, 315 are provided which are controllable to connect at least one individual row 305 between external drive and measurement electronics. A challenge will include (at a minimum) an identification of sensor elements (in this case, a pair of row addresses) to be measured, the identified rows are (e.g., sequentially) connected to external measurement electronics by the row decoders, and some property, typically an electrical property, of the selected rows is measured. Response bits may be generated by comparing the relative response to environmental stimulus being generated between the row pair identified by the challenge. This disclosure is not limited in the types of electrical measurements that may done on individually addressable sensor elements, which will depend on the nature of the sensor. Where the sensors are resistive sensors, like the ferroelectric sensors of FIG. 3, each individual sensor element will take on a resistance value depending on what sort of environmental stimulus it is designed to sense (e.g., an amount of heat, light, etc.). In the aggregate, an aggregate signal for the whole sensor reflecting the environmental signal is output, then subject to calibration, and is then usable for whatever purpose. Generally, each sensor element will produce an output that is proportional to the aggregate or whole sensor signal, but the relation of each sensor's responsivity or output to the sensor signal as a whole is different than that of the other sensors, and may be different depending on the magnitude of the environmental input signal. Each individual sensor element will generally have a responsivity curve or function that maps the environmental input on the sensor element to its electrical output and the shapes of these curves will differ, sensor element to sensor element. Thus, the responsivities of individual sensor elements within the whole sensor (e.g., each row of sensor 300) will vary from one another however. This means the individual outputs of each individual sub sensor element will vary for a given environmental stimulus, and the variation will be random. The resistance of individual rows may be measured and compared, and multiple relative measurements of this sort will generate a unique fingerprint for the device. Optionally, the sensor may be subject to some additional controlled stimulus, such as an electrical stimulus that is also supplied to the device. This may involve supplying an injection current of some value, which would also be included in the challenge instructions. The resistance of the row might then be measured, i.e., across the row (as in case 2 of FIG. 3), or between the row and a common ground plane (as in case 1). Whatever measurement modality is selected, however, should be fast, in contrast to the measurement of ring oscillators discussed above in reference to FIG. 1.

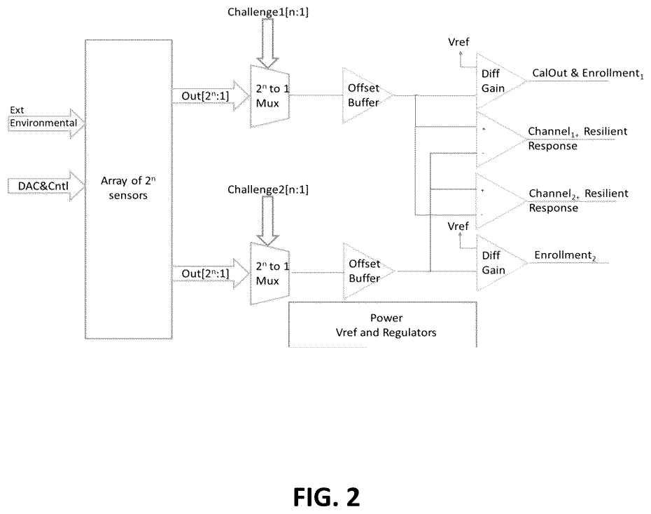

FIG. 2 shows a hardware arrangement usable with sensors having individually addressable elements. Like the ring oscillator PUF of FIG. 1, a random challenge is sent to the array consisting of the address of the two rows of sensors chosen. Unlike the ring oscillator PUF of FIG. 1 that measures the relative frequency of the two elements, the sensing rows are compared in their response to external or electrically generated environmental stimulus. In the ring oscillator PUF the frequencies of the two oscillators are compared, while in the sensor PUF the electrical outputs such as voltage, current, charge, capacitance, resistance, or other response to environmental stimuli are compared.

As shown in FIG. 2, a sensor 200 has multiple, individually addressable and measurable sub-elements. In the example of FIG. 2, sensor 200 is a ferroelectric sensor having 2ⁿ rows of ferroelectric cells or other sensing elements where n is an integer. Because the sensor is operating as a sensor, it is subject to some environmental input signal 205 (e.g., the heat, light, pressure or whatever physical, environmental quality the sensor is measuring). The sensor produces an electrical output that represents the measured environmental input, and that electrical output is typically calibrated to a calibrated electrical system using calibration data, as discussed above. Typically, and preferably, the sensor output is the result of the response of all individually addressable sensor elements in the sensor, which are operating in the aggregate (e.g., being summed or averaged). In the arrangement of FIG. 2, in addition to some aggregate output signal, electrical properties of individual sensor elements, such as rows of devices, are capable of being measured. This is shown by two row outputs 215. Two row outputs (and generally, two individual sensor elements) may be measured by connecting sensor 200 to two multiplexers 220, each of which is capable of connecting to a single sensor element (in this case, a row). The sensor outputs of two rows are compared and if a first row (e.g., the first row identified in the challenge) is higher than the output of the second row, the binary response to the challenge is a first binary symbol (e.g., a 1). If the second identified row's output is higher than the first row's the binary response the challenge (or the challenge segment) is the second binary symbol (e.g., a 0). One way to provide this sort of differential measurement of sensor element outputs is to provide both outputs to a comparator 225. A preferred way of doing this is to provide both row outputs to a pair of comparators, but for the first comparator, connecting the first row output to the non-inverting input and the second row output to the inverting input, and then swapping the connections for the second comparator. In this sort of arrangement, the binary outputs of the comparators will always be opposite from one another, which has the advantage of forcing the entire device to consume the same amount of power and current regardless of the binary value being returned. This is advantageous in mitigating against side channel attacks, which may be able to detect power use spikes in the client device.

In the arrangement of FIG. 2, the individual raw output of each sensor element may also be provided through outputs 230. These outputs may be used in a variety of ways. First, these outputs are a reflection of the environmental stimulus on the sensor. They will generally not be perfect indications of the strength of the environmental signal because they may be uncalibrated. Additionally, there may not be calibration data stored for each individual sensor element (e.g., each row) in the calibration table, which in most cases will store calibration data for the aggregate sensor. Additionally, there may be some structural reason why a particular row or other individually addressable sensor element is not representative of the aggregate sensor and therefore, individually, will return highly inaccurate raw output data. That said, the outputs of individual sensor elements may include useful information or be useful to generate useful information. For example, individual sensor element output can be compared to aggregate sensor output and large differences between the two could indicate a bad sensor element.

As will now be further described, the comparison circuitry shown in the schematic of FIG. 2 is capable of: 1) comparing the response of the two array rows to determine if the cryptographic output is a zero or one, 2) determine if one of the array rows has been damaged or is faulty in any way, 3) measure the external environmental conditions that the row of sensors is responding to:

As noted throughout this disclosure, individual sensor elements, such as the rows of sensor 200, have small variations in their responses to environmental conditions and external electric fields (or other external electrical stimulus) that can be used as a fingerprint of the device. These differences may be measured in a secure location and stored in the client device's server in the Enrollment.

The arrangement of FIG. 2 may include an External Digital to Analog Converter (DAC) to provide further electrical stimulus and Control circuitry 210 used to address a pair of rows. The DAC circuitry is capable of manipulating the sensor response by adding an electrical stimulus (e.g., bias voltage, injection current, etc.), which simulates changing the environmental conditions to which the sensor is responding. The control circuitry outputs the addresses of the two array rows to be selected, which are fed to the selection devices, in this case the multiplexers 220. This allows for a greater entropy in the Responses.

Individual sensor element outputs 230 may also be used for enrollment of the sensor elements. In preferred embodiments, to measure the PUF image, the response of each sensor element is measured over the range of environmental stimulus (heat, pressure, etc.) that the sensor will experience during use. These measurements are stored in the image table (e.g., at a separate server device, but optionally at the client device). Differences between entries in these table for pairs of elements are the expected responses that will be compared with actual, contemporaneously measured responses during cryptographic and authentication operations. Thus, the image constitutes the fingerprint of the device, which is taken in a secure location by varying the environmental conditions and optionally DAC settings that combine to create a Challenge and measuring the Responses through the Enrollment channels. The results called the Challenge/Response Pairs (CRPs) are stored in a table in the client device's server.

To measure responses, a random seed or key is generated. The seed is segmented into segments each of which is large enough to be read as encoding a pair of sensor element addresses, and optionally, additional measurement conditions. Each of these segments is a challenge, and the sensor PUF is challenged by sending the stream of row address pairs, for example 256 row address pairs, comparing the outputs and extracting 256 bits (Responses). The value of the Response is determined by which of the Channel₁ or Channel₂ outputs is higher.

In certain optional embodiments, an additional electrical stimulus (e.g, a bias voltage or probe current) may be provided to one or more of the addressable sensor elements (e.g., through input 210). In these cases, this additional electrical stimulus should be accounted for and provided during enrollment as well. In these cases, the output response of each measured sensor element is the combined effect of both the environmental signal and the additional electrical signal.

During each Challenge the electrical output corresponding to the external environmental plus optional electrically induced environmental conditions are available through the CalOut channel. The Enrollment₂ channel may be disabled after enrollment, so the enrollment data cannot be read outside of the secure enrollment station.

During each Challenge the continued health of the sensor may be checked in real-time by comparing the computed difference between the two array elements from the Challenge/Response pairs to the actual measured difference from the Resilient Response Channels.

During challenge generation, pairs of elements that have too similar responses may be masked and discarded from the Challenge set sent to the client device.

The response generation of the fingerprint should be in the 10 ms range, or faster.

In certain embodiments, during calibration of the sensor, a plurality and preferably each individual sub-element of the sensor, that is, preferably each individual addressable sensor element, is calibrated separately, and the sensor's calibration table includes calibration data for each individual sensor element. In these cases, the image of the sensor puf can be populated with calibrated or uncalibrated response data, or both. Additionally, the measured responses can be on the basis of calibrated or uncalibrated sensor data, or both. In certain cases, calibration data for sensor elements can be measured and stored for just some of the elements, e.g., certain rows, and not others. In yet other embodiments, instead of measuring responses using actual environmental inputs (e.g., by actually ramping temperature or pressure or the like, as would be done during calibration), the responses are measured with the application of electrical signals that simulate exposure of the senor elements to the natural phenomenon. This would be done both for enrollment and for actual response measurement.

In use, in cases where the sensor element responses are being driven by external electrical signals as well as environmental inputs, the sensor can be switched to a sensing mode by zeroing out the DAC controlled part of the environmental stimulus. The environmental input could then be measured by selecting one of the calibrated array rows for Channel₁ and a random array element for Channel₂. The Channel₁-Channel₂ differential reading is compared to the expected value from the Challenge/Response table to determine if the calibrated sensor is still operating correctly.

The architecture that has just been described has many advantages, one of which is the ability to detect failing senor elements and/or malicious error injection attacks. This can be done in a number of ways. First, if calibration data was generated for an individual sensor element, the calibrated output of the individual sensor element can be compared to either, or both, of the calibrated output of the sensor as a whole, or the calibrated output of another sensor element. All of those comparisons should match for all levels of environmental stimulus, and when they fail to match above some threshold, that is an indication that the one sensor element or the sensor as a whole is faulty. Second, a response stream from a challenge stream can be compared to stored response data (i.e., from enrollment), and if they do not match, above some threshold, one or more sensor segments is bad. This situation is the equivalent of a client device authenticating itself with its own PUF image. This will, in most cases, be done with a PUF image stored at the device itself, which makes that PUF image less useful for secure communications or authentication by a second party, such as a server.

Another possibility is that a sensor is used as effectively two completely separate CRP generation mechanism. This could be done, for example, by using an electrical stimulus to general a first set of enrollment responses, which are stored at the server. Environmental stimulus (e.g., ramping voltage, temperature, etc.) is then used to generate a second set of enrollment responses that are stored at the client device. The second set of responses can be continually elicited in real time and compared to the client-stored responses to verify sensor operation while the sensor is sensing environmental data. The first set of responses could be elicited and used periodically, e.g., to generate session keys for communication with the server, or in response to authentication queries from a server.

### Experimental Validation:

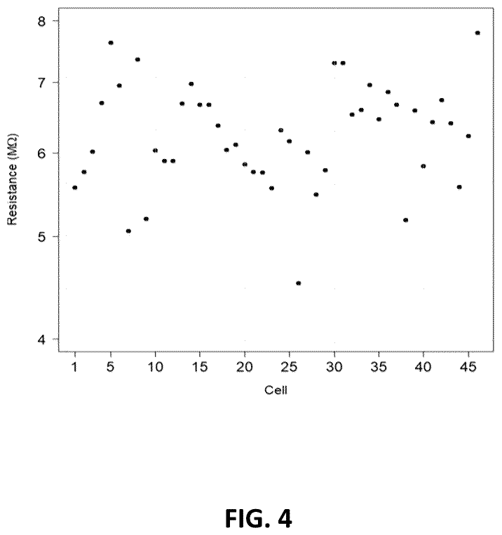

FIG. 4 presents an example of how device fingerprinting can be achieved using cell-to-cell variations. The figure displays the variations of Hafnium Zirconium Oxide (HZO) ferroelectric thin films, which were measured at 400 nA current injection. The films had an area of 80 um², and the y-axis represents the measured response while the x-axis represents the cell location in the array. The response space ranges from 4 to 8 Mega-Ohm at 400 nA, and the standard deviations between cells are in the hundreds of kilo-Ohm ranges. The relative deviations are in the tens of kilo-ohms range, allowing for high reproducibility and uniqueness for CRP generation.

The design of physical unclonable functions can be based on the inherent differences in the cells due to various manufacturing process variations, such as the density of defects. Moreover, these differences can also lead to significant differences in delay times when utilizing a row of cells in an array to produce a unique response.

The ferroelectric has unique electrical properties that enable it to sense various physical and environmental parameters, including pressure, temperature, force, and imaging sensing. It can act as both a device fingerprint and a sensor. An array of sensors offers advantages over a single sensor as it adds new dimensions to the observation, helping to estimate more parameters and improve the estimation performance, thus enhancing the sensing capabilities of the ferroelectric sensor array.

The described features, advantages, and characteristics may be combined in any suitable manner in one or more embodiments. One skilled in the relevant art will recognize that the circuit may be practiced without one or more of the specific features or advantages of a particular embodiment. In other instances, additional features and advantages may be recognized in certain embodiments that may not be present in all embodiments.

Reference throughout this specification to “one embodiment,” “an embodiment,” or similar language means that a particular feature, structure, or characteristic described in connection with the embodiment is included in at least one embodiment. Thus, appearances of the phrase “in one embodiment,” “in an embodiment,” and similar language throughout this specification may, but do not necessarily, all refer to the same embodiment.

What is claimed is:

1. A system comprising:
a sensor system comprising:
a sensor configured for receiving as input at least an environmental stimulus and outputting an electrical sensor signal in response to the environmental stimulus, the electrical sensor signal reflecting a magnitude of the environmental stimulus, wherein the electrical sensor includes a plurality of individually addressable sensor elements, and the electrical sensor signal is a function of output signals from the plurality of individually addressable sensor elements;
addressing circuitry configured to, in response to a control signal, select output signals from two of the plurality of individually addressable sensor elements and supply the selected signals to comparison circuitry;
wherein the comparison circuitry compares the selected output signals and outputs a first or second binary signals depending on which output signal from the individually addressable sensor elements is larger.

2. The system of claim 1, wherein the output signals from the plurality of individually addressable sensor elements comprise responses to the environmental stimulus.

3. The system of claim 1, further including circuitry to select individually addressable sensor elements and supply electrical stimulus to the selected sensor elements, and wherein the output signals from the plurality of individually addressable sensor elements comprise responses to the supplied electrical stimulus.

4. The system of claim 1, further including a programmable processor in communication with non-volatile storage, the non-volatile storage including computer readable instructions executable by the programmable processor to perform steps comprising:
generating a bitstream;
segmenting the bitstream into n challenges;
reading each of the n challenges as identifying addresses of a pair of individually addressable sensor elements;
controlling the addressing circuitry to select output signals from pairs of individually addressable sensor elements identified in the n challenges; and
storing a bitstream of n binary responses corresponding to the binary output of the comparison circuitry.

5. The system of claim 1, wherein generating a bitstream comprises one of generating the bitstream with a random number generator, receiving the bitstream from an external device or receiving a seed and generating the random bitstream using the seed.

6. The system of claim 1, further including a programmable processor in communication with non-volatile storage, the non-volatile storage including computer readable instructions executable by the programmable processor to perform steps comprising using the bitstream of n responses to generate an encryption key.

7. The system of claim 6, wherein, using the bitstream of n responses to generate an encryption key includes using at least a portion of the bitstream of n responses as an encryption key.

8. The system of claim 1, further including a programmable processor in communication with non-volatile storage, the non-volatile storage including computer readable instructions executable by the programmable processor to perform steps comprising using the bitstream of n responses as an encryption key.

9. The system of claim 1, further including a programmable processor in communication with non-volatile storage, the non-volatile storage including computer readable instructions executable by the programmable processor to perform steps comprising comparing an indicia of at least of portion of the bitstream of n responses to an indicia of previously generated and measured responses.

10. The system of claim 1, further including a programmable processor in communication with non-volatile storage, the non-volatile storage including computer readable instructions executable by the programmable processor to perform steps comprising receiving a subset of m previously generated and measured responses and comparing the subset of m responses to the bitstream of n responses to generate an encryption key.

11. The system of claim 10, wherein comparing the subset of m responses to the bitstream of n responses to generate an encryption key comprises construction an encryption key by locating positions in the bitstream of n responses that match responses in the subset of m responses, for matching locations, assigning the key a first binary symbol and for non-matching locations, assigning the key a second binary symbol.

12. The system of claim 1, further including a programmable processor in communication with non-volatile storage, the non-volatile storage including computer readable instructions executable by the programmable processor to perform steps comprising storing the bitstream of n binary responses corresponding to the binary output of the comparison circuitry in associated with an indication of environmental stimulus input to the sensor during measurement of the n responses.

13. The system of claim 1, further comprising:
circuitry to select individually addressable sensor elements and supply electrical stimulus to the selected sensor elements, and wherein the output signals from the plurality of individually addressable sensor elements further comprise responses to the supplied electrical stimulus;
a programmable processor in communication with non-volatile storage, the non-volatile storage including computer readable instructions executable by the programmable processor to perform steps comprising:
generating a bitstream;
segmenting the bitstream into n challenges;
reading each of the n challenges as identifying addresses of a pair of individually addressable sensor elements and a degree of electrical stimulus to be applied to identified sensor elements;
controlling circuitry to select individually addressable sensor elements and supply the identified electrical stimulus to the selected sensor elements in accordance with the n challenges;
controlling the addressing circuitry to select output signals from pairs of individually addressable sensor elements identified in the n challenges; and
storing a bitstream of n binary responses corresponding to the binary output of the comparison circuitry.

14. A method of generating a set of responses from a set of challenges, comprising:
providing a sensor configured for receiving as input at least an environmental stimulus and outputting an electrical sensor signal in response to the environmental stimulus, the electrical sensor signal reflecting the magnitude of the environmental stimulus, wherein the electrical sensor includes a plurality of individually addressable sensor elements, and the electrical sensor signal is a function of output signals from the plurality of individually addressable sensor elements;
generating a challenge bitstream and parsing the challenge bitstream into n challenges, each of which identifies, at least, a pair of the plurality of individually addressable sensor elements;
for each of the pair of the plurality of individually addressable sensor elements, measuring a relative response of the pair to the environmental stimulus, where the response is a first binary symbol if a response of first sensor element in the pair is higher than a second, and a second binary symbol if the response of the second sensor element in the pair is higher than the first, resulting in a set of n binary responses.

15. The method of 14, including storing the set of n binary responses along with data reflecting a magnitude of an environmental stimulus on the sensor when the responses were measured.

16. The method of claim 14, further comprising using the set of n binary responses to generate an encryption key.

17. The method of claim 14, further comprising comparing an indicia of at least of portion of the set of n binary responses to an indicia of previously generated and measured responses.

18. The system of claim 14, further comprising receiving a subset of m previously generated and measured binary responses and comparing the subset of m responses to the set of n responses binary to generate an encryption key.

19. The system of claim 18, wherein comparing the subset of m responses to the set of n responses to generate an encryption key comprises constructing an encryption key by locating positions in the bitstream of n responses that match responses in the subset of m responses, for matching locations, assigning the key a first binary symbol and for non-matching locations, assigning the key a second binary symbol.

20. A method of generating a cryptographic key pair, comprising:
at a server device, performing an enrollment process comprising:
generating a seed bitstream S;
deriving from the seed bitstream S a set of n challenges, each challenge identifying, at least, a pair of individually addressable sensor elements in a senor device configured for receiving as input at least an environmental stimulus and outputting an electrical sensor signal in response to the environmental stimulus, the electrical sensor signal reflecting the magnitude of the environmental stimulus, wherein the electrical sensor includes a plurality of individually addressable sensor elements and the electrical sensor signal is a function of output signals from the plurality of individually addressable sensor elements;
for each of the pair of the plurality of individually addressable sensor elements identified by a challenge, measuring a relative response of the pair to the environmental stimulus, where the response is a first binary symbol if a response of first sensor element I n the pair is higher than a second, and a second binary symbol if the response of the second sensor element in the pair is higher than the first, resulting in a set of n binary responses;
generating a binary key k;
filtering the set of n binary responses by removing responses in the set that have positions corresponding to positions of 0s in K, resulting in a subset of m responses;
sending data to a client device in possession of the sensor device, from which the client device can derive S and the subset of m responses;
at the server device, performing a recognition process comprising:
generating the set of n challenges using S;
applying the n challenges to the sensor, resulting in a set of n client responses, and
comparing the set of n client responses to the subset of m responses.
